(19) United States
(12) Patent Application Publication
(10) Pub. No.: US 2024/0226867 A1
(43) Pub. Date: Jul. 11, 2024

(54) COATING PROCESS FOR A WALL-FLOW FILTER

(71) Applicant: UMICORE AG & CO. KG, Hanau-Wolfgang (DE)

(72) Inventors: Astrid MUELLER, Alzenau (DE); Martin FOERSTER, Buedingen (DE); Manuel GENSCH, Aschaffenburg (DE)

(73) Assignee: UMICORE AG & CO. KG, Hanau-Wolfgang (DE)

(21) Appl. No.: 18/556,970

(22) PCT Filed: May 18, 2022
(86) PCT No.: PCT/EP2022/063383

§ 371 Date: Oct. 24, 2023

(30) Foreign Application Priority Data
May 19, 2021 (DE) 10 2021 112 955.9

(51) Int. Cl. B01J 37/02; B01D 53/94; B01J 35/31; B01J 35/56; F01N 3/20; F01N 3/28

(52) U.S. Cl. CPC B01J 37/0228; B01D 53/9418; B01J 35/31; B01J 35/56; B01J 37/0236; F01N 3/2066; F01N 3/2803; B01D 2255/9155; B01D 2258/012; F01N 2510/068

(57) ABSTRACT

The present invention relates to a method for coating wall-flow filters. It also relates to correspondingly produced wall-flow filters and to their use in exhaust gas cleaning.

The present invention relates to a method for coating wall-flow filters. It also relates to correspondingly produced wall-flow filters and to their use in exhaust gas cleaning.

The exhaust gas of, for example, combustion engines in motor vehicles typically contains the harmful gases carbon monoxide (CO) and hydrocarbons (HC), nitrogen oxides (NOₓ), and possibly sulfur oxides (SOₓ), as well as particulates that mostly consist of soot particles in the nanometer range and possibly adherent organic agglomerates and ash residues. These are called primary emissions. CO, HC, and particulates are products of the incomplete combustion of the fuel inside the combustion chamber of the engine. Nitrogen oxides form in the cylinder from nitrogen and oxygen in the intake air when the combustion temperatures locally exceed 1400° C. Sulfur oxides result from the combustion of organic sulfur compounds, small amounts of which are always present in non-synthetic fuels. For the removal of these emissions, which are harmful to health and environment, from the exhaust gases of motor vehicles, a variety of catalytic technologies for the purification of exhaust gases have been developed, the fundamental principle of which is usually based upon guiding the exhaust gas that needs purification through a catalyst consisting of a flow-through or wall-flow honeycomb-like body (wall-flow filter) and a catalytically active coating applied to and/or in it. The catalyst in the coating facilitates the chemical reaction of different exhaust gas components, while forming non-hazardous products, such as carbon dioxide and water.

The soot particles may be very effectively removed from the exhaust gas with the aid of particle filters. Wall flow filters made of ceramic materials have proved particularly successful. These have two end faces and are constructed from a plurality of parallel channels of a certain length, which are formed by porous walls and which extend from one end face to the other. The channels are alternately sealed in a gas-tight manner at one of the two ends of the filter so that first channels are formed that are open at the first side of the filter and sealed at the second side of the filter, and second channels are formed that are sealed at the first side of the filter and open at the second side of the filter. In accordance with the arrangement of the filter in the exhaust gas flow, one of the end surfaces here forms the inlet end surface and the second end surface forms the outlet end surface for the exhaust gas. The flow channels that are open at the inlet side form the inlet channels, and the flow channels that are open at the outlet side form the outlet channels. The exhaust gas flowing into the first channels, for example, may leave the filter again only via the second channels and must flow through the walls between the first and second channels for this purpose. For this purpose, the material from which the wall flow filters are constructed exhibits an open-pored porosity. The particles are retained when the exhaust gas passes through the wall.

As stated, wall-flow filters can be catalytically active. The catalytic activity is achieved by coating the filter with a coating suspension which contains the catalytically active material. The contacting of the catalytically active materials with the wall flux filter is referred to in the art as “coating.” The coating takes on the actual catalytic function and frequently includes storage materials for the exhaust gas pollutants and/or catalytically active metals that are for the most part deposited in a highly dispersed form onto temperature-stable metal compounds, in particular oxides, with a large surface area. The coating for the most part takes place via the application of an aqueous suspension of the storage materials and catalytically active components—also called a washcoat—onto or into the wall of the wall flow filter. After the application of the suspension, the support is usually dried and, if applicable, calcined at increased temperature. The coating may consist of one layer or be made up of multiple layers that are applied atop one another (multi-layered) and/or offset relative to one another (as zones) onto a corresponding filter. The catalytically active material can be applied to the porous walls between the channels (what is known as on-wall coating). However, this coating can lead to an unacceptable increase in the back pressure of the filter. With this as the background, JPH01-151706 and WO2005016497A1, for example, propose to coat a wall flow filter with a catalyst such that the latter penetrates through the porous walls (what is known as in-wall coating). A zone is understood to mean the presence of a catalytically active material (coating) on or in the wall of the filter over less than the entire coatable length of the wall-flow filter.

A coating technique for wall-flow filters is described in WO06021338A1. Here, the wall-flow filter is made of an open-pore material, has a cylindrical shape having the length L and is traversed from an inlet end surface to an outlet end surface by a plurality of flow channels that are alternately closed. The coating suspension is applied by perpendicularly aligning the flow channels of the wall flow filter such that one end face is located at the bottom and the second end face at the top, by introducing the coating composition into the filter body through the flow channels of the wall flow filter that are open in the lower end face to a desired height above the lower end face by applying a pressure difference and removing excess coating composition downward by applying a suction pulse. The specific modifications of this method according to WO 06042699A1 and WO 11098450A1 are based on the same coating principle. A coating apparatus using this method principle is presented in WO 13070519A1. Here, too, an excess of coating suspension and the principle of applying the pressure difference reversal are used to remove excess coating suspension.

This coating principle is also suitable for producing particle filters which have zones with catalytically active material on the inlet and outlet sides. In WO 09103699A1, a method for coating filters with two different washcoats is described, the method steps being that the filter substrate is oriented vertically, a first coating suspension is pumped from below (pressure difference with highest pressure at the lower end), the excess coating suspension removed through suction (pressure difference reversal) and the filter body is filled again from below with the second washcoat after rotation by 180°, and the excess is removed by suction. The filter is dried and calcined after the coating process. The same coating principle is disclosed in U.S. Pat. No. 7,094,728B2. Coated wall-flow filters produced in this way frequently have a gradient in the coating.

The patent specification U.S. Pat. No. 3,331,787 discloses a method for producing a catalytically active flow-through substrate in which a ceramic honeycomb carrier is coated with a noble-metal-containing oxide suspension. In a preferred embodiment, the open pores of the channel walls of the flow-through substrates are filled with water before coating with the oxide suspension (washcoat) by immersing the carrier in water and then blowing out excess water with air pressure.

EP0941763B1 describes a process for coating the flow channels of a honeycomb-shaped catalyst body with a coating dispersion. Ceramic catalyst supports therefore have a considerable capacity to absorb the liquid content of the coating dispersion in the dry state, which results in the coating dispersion solidifying due to the water loss during the filling of the carriers. As a result, the flow channels can be blocked or coated unevenly. As a solution, EP0941763B1 provides that the catalyst supports be wetted before coating with the dispersion. Pre-impregnation with acids, bases or salt solutions is proposed for moistening.

EP1110925B1 also describes a method for coating ceramic flow-through substrates, in which the absorbency of partial regions of the carrier is reduced by pre-moistening. In the context of this invention, moistening is understood to mean the coating of the porous honeycomb body with any liquids or solutions, preferably aqueous in nature. In this case, the partial moistening of the carrier includes in particular the pre-loading of the lateral surface and outer partial regions of the flow-through substrate with water in order to prevent the channels from becoming blocked in these regions.

U.S. Pat. No. 7,867,936 describes a method for passivating porous ceramic substrates by filling the pores and microcracks with water. During subsequent coating with a coating suspension, this measure prevents the oxide particles contained in the coating suspension from penetrating into the microcracks and filling and closing them after drying and calcination. By filling the microcracks and pores with oxide particles, the thermal shock resistance of the catalyst substrates would otherwise be significantly reduced during thermal cycling. The pre-coating of the porous carriers (for example DPF filter substrates) with water is carried out by dipping, spraying or passing steam or water vapor through until the moisture content of the substrate is between 2% by weight and 15% by weight.

The quality of a catalytically coated exhaust filter is measured according to the criteria of filtration efficiency, catalytic performance and pressure loss. In order to meet these different requirements, filters are coated in a wide variety of ways. It is still an object to be able to provide improved filters with respect to one or more of the aforementioned criteria, depending on the requirements profile.

These and other objects evident from the prior art for the person skilled in the art are achieved by a method and the correspondingly produced wall-flow filter according to independent claims 1 and 8. Preferred embodiments of the method and of the wall-flow filter are addressed in the claims dependent on these claims. Claims 9 and 10 relate to a corresponding wall-flow filter. Claim 11 relates to a use of the wall-flow filter.

By bringing the wall-flow filter into contact with a liquid comprising water in a first step in a method for coating a wall-flow filter with a coating suspension that gives the filter a catalytic activity during exhaust gas cleaning and applying a coating suspension to the wall-flow filter in a second step, wherein the coating suspension is one that meets one of the following criteria:
Q3 values of the grain size distribution (d90−d10)/d50<5 of the particles present in the suspension;
viscosity <2000 mPas at a shear of 20 1/s;

the solution to the stated aim is attained surprisingly, but in no less advantageous a manner. The coating suspensions described are rapidly dewatering suspensions. During the coating of a wall-flow filter with such a suspension, an extremely pronounced coating gradient is normally produced in the coating direction, because the coating suspension penetrating from below into the channels of the wall-flow filter increasingly loses liquid the further it penetrates into the channels. Thus, there is the risk that the channels of the wall-flow filter to be coated are quickly clogged with the coating suspension. Any partial pre-wetting of the inner walls of the wall-flow filter with a liquid comprising water can counteract this. This results in a later, possibly undesired, gradient in the amount of coating suspension on or in the walls along the longitudinal axis of the filter. A more uniform homogeneous coating is the result.

The essential factors for characterizing the particle size distribution are the d10, d50 and d90 values based on the number of particles in the sample. The d50 or also the central or median value, for example, indicates the mean value of the particle sizes and means that 50% of all particles are smaller than the given value. For the d10 value, 10% of all particles are smaller than this value and 90% are larger. Corresponding definitions apply for the d90 value.

These values are usually determined by means of laser diffraction methods. In the indicated values of the grain size, the particle size is measured by way of the laser diffraction method in an aqueous suspension according to ISO 13320-1 (latest version valid on the filing date). ISO 13320-1 Particle Size Analysis—Laser Diffraction Methods describes the method widely used in the art for determining the grain size distribution of particles in the nanometer and micrometer range by way of laser diffraction. In laser diffraction, particle size distributions are determined by measuring the angular dependence of the intensity of scattered light of a laser beam penetrating a dispersed particle sample.

The shear-rate-dependent viscosity can be measured using a plate cone rheometer (manufacturer Malvern, type Kinexus or manufacturer Brookfield, type RST) according to DIN 53019-1:2008-09 (latest version valid on the filing date). The viscosity of the coating suspension is <2000 mPas at a shear of 20 1/sec. Preferably, the viscosity is <1500 mPas, more preferably <1000 mPas at the same shear. A lower limit can be >200 mPas, more preferably >400, and very particularly preferably >600 mPas, each at corresponding shears. These values can be combined as desired and give the person skilled in the art a rough framework for the successful application of the method.

The person skilled in the art can take as water-comprising liquids those which prove advantageous for the present purpose. In the simplest case, only water is applied to the filter. However, it should also be mentioned that, for example, water/alcohol, acidic or basic solutions or water/surfactant mixtures can be used for the present purpose. It is also possible to use salt solutions or low-viscosity suspensions in this context. “Low viscosity” (DIN 53019-1:2008-09, latest version valid on the filing date) means a viscosity of less than 300 mPas, preferably less than 100 mPas at a shear of 100 1/s. In this case, suitable salts are also those which, after the calcination of the wall-flow filter, impart a catalytic activity thereto. Such salts are very well known to the person skilled in the art of automotive exhaust gas catalyst production from impregnation studies. He will be able to select the corresponding salts from his list against the background of the cleaning problem and apply them to the filter accordingly as an aqueous solution.

When the wall flow filter is contacted with the liquid having water in the first step, it is possible to wet the filter completely. This can be done by means of measures familiar to the person skilled in the art (e.g. simple dipping). However, it is also possible for the filter to come into contact with the liquid only to a certain extent. Accordingly, it is possible to apply the liquid only where it is needed. Accordingly, it can be advantageous for the wall-flow filter to be contacted with the liquid only over less than the entire length of the filter. The region of contact can be from one end of the filter over <80%, more preferably <60% and most preferably <40% of the length of the filter. A lower limit may be >10%, more preferably >20%. The specified limit values are to be selected by the person skilled in the art according to the coating problem and can be combined as desired.

After the first wetting step, the coating suspension can be introduced into the filter. In this case, the coating suspension is preferably introduced in excess into the wall-flow filter from below by applying a pressure difference across the vertically locked wall-flow filter, and subsequently a pressure difference reversal removes an excess of the coating suspension from the wall-flow filter. During contacting of the wall-flow filter with the liquid comprising water in the first step, the wall-flow filter can preferably already be present in the coating station in a vertical orientation. The coating suspension can then be applied very easily as just described in the second step. This eliminates the need to change the wall-flow filter on the process side.

Initially, the suspension has a large proportion of liquid components. It is therefore comparatively low in viscosity. This changes as the suspension is progressively applied to the filter. From a certain region, it is then advantageous if the wall of the wall-flow filter was correspondingly wetted with the liquid comprising water in order to reduce a further increase in the viscosity of the coating suspension during the further coating. Preferably, therefore, the liquid comprising water is only applied to the filter where the thickening suspension will also cause problems later. The aforementioned regions for the wetting can be used here. Thus, in the second step, the coating suspension is very preferably introduced in excess into the wall-flow filter from below by applying a pressure difference across the vertically locked wall-flow filter, and subsequently a pressure difference reversal removes an excess of the coating suspension from the wall-flow filter again.

It is particularly preferred if, in a corresponding system for coating wall-flow filters from below with a pressure difference and an excess of coating suspension and subsequent pressure difference reversal (see introduction for literature), the wetting with the liquid comprising water is also carried out from below as a first step, advantageously with the same device. The filter can then be rotated by 180° before the coating suspension is introduced into the filter again from below. This ensures that wherever the coating suspension would reach too high a viscosity during coating without prior wetting with a liquid comprising water, such high viscosity is at least reduced, if not completely prevented, by the wetting there. On the one hand, this has the advantage that the coating suspension, as mentioned above, does not become too viscous and therefore an orderly coating of the wall-flow filter is made difficult. On the other hand, this also means that the excess of coating suspension removed from the wall-flow filter by the pressure difference reversal is not dewatered too much. This excess is fed back into the initial batch in coating campaigns of the coating suspension in order to avoid wasting expensive coating suspension. As a result, however, the viscosity of the coating suspension in the initial batch also increases during a coating campaign and deviates more and more from the original coating properties. Complications during the coating campaign are therefore pre-programmed. By pre-wetting the wall-flow filter with the liquid comprising water, this disadvantage is therefore also compensated for, because the returned coating suspension is less dewatered.

As already mentioned above, the coating suspension can be applied onto and/or into the wall of the wall-flow filter. The person skilled in the art knows which measures must be taken to achieve the desired result. To produce an on-wall coating (>50% by weight of the solid components of the suspension remain above the wall surface of the channel; see below for determination), coarser particle distributions are necessary. The average particle size D50 of the Q3 distribution in the suspension in relation to the average pore diameter D50 of the Q3 distribution can preferably be >33%, more preferably >40% and particularly preferably >45%. The pore diameter of the filter wall is determined by mercury porosimetry, which is a basic method for determining pore size and pore volume and from which the pore size distribution can be derived. The measurement is performed according to DIN 66133 (latest version on the filing date).

Alternatively, the coating suspension can also be predominantly (>50% by weight of the solid components of the suspension) present in the wall of the filter after coating (determined by image analysis of CT images of the filter or optical evaluation of microscopic micrographs after drying). One possibility for determining and evaluating the washcoat distribution in the filter wall via optical image analysis is described by way of example in patent specification U.S. Pat. No. 2,018,095. Very particularly preferably, for a coating in the wall of the filter, more than 70% by weight of the solid components of the suspension and very particularly preferably more than 90% by weight are present in the wall. In particular, this result can be achieved by correspondingly reducing the particles used in the coating suspension so that they fit into the pores of the filter. Therefore, an embodiment in which the mean particle size d50 of the Q3 distribution in the coating suspension in relation to the average pore diameter D50 of the Q3 distribution is <20% is preferred for this distribution. Very preferably, this ratio is <10% and most preferably less than 5%.

One factor in the present method is the density of the coating suspension used. This can be determined, for example, by means of an areometer according to DIN 12791-1:2011-01 (latest version on the filing date). It is advantageous if the coating suspension has a density between 1050 kg/m³ and 1700 kg/m³. More preferably, said density is between 1100 kg/m³ and 1600 kg/m³ and particularly preferably between 1100 kg/m³ and 1550 kg/m³.

The method used here makes it possible to achieve the most homogeneous coating possible on or in the wall-flow filter. Homogeneous in this sense means that the amount of coating suspension along the longitudinal axis of the filter is as constant as possible. Advantageously, after the coating and subsequent drying of the coated filter, the gradient of the coating suspension in the longitudinal direction is below 10%, preferably below 5% and very preferably below 3%. This is measured by averaging the amount of coating in the first third of the coating and in the last third of the coating by weighing and forming the corresponding ratio.

In a further preferred embodiment of the present method, the applied pressure difference for filling the filter with washcoat is between 0.05 and 4 bar, preferably between 0.1 and 2 bar, and particularly preferably between 0.5 and 1.5 bar. For this purpose, the pressure difference used for filling is preferably between 0.05 bar and 2 bar, more preferably between 0.07 and 1 bar and particularly preferably between 0.09 and 0.7 bar. For the pressure difference reversal, the person skilled in the art will preferably refer to the method specified in DE102019100107A1.

A further subject matter of the present application is a wall-flow filter produced according to the invention. The embodiments mentioned as preferred for the method also apply mutatis mutandis to the wall-flow filter referred to herein. The wall-flow filter can be provided with various catalytically active coatings. In particular, these are coatings that have three-way activity and a diesel oxidation catalyst or are active in ammonia oxidation or nitrogen oxide reduction by means of ammonia. Most preferably, the filter is provided with an SCR-active coating suspension, preferably to the greatest extent possible in the wall.

The present invention likewise provides for the use of a filter according to the invention after drying and optionally calcination, preferably for reducing harmful exhaust gas components of internal combustion engines. In principle, all exhaust gas aftertreatments which are suitable to a person skilled in the art for this purpose can be used as such. Preferably, filters having the above-indicated catalytic properties, but in particular SCR catalysts, are used. The wall-flow filters produced using the method according to the invention are suitable for all these applications. The use of these filters for the treatment of exhaust gases of a lean burning car engine is preferred.

All ceramic materials customary in the prior art can be used as wall-flow monoliths or wall-flow filters. Porous wall-flow filter substrates made of cordierite, silicon carbide, or aluminum titanate are preferably used. These wall-flow filter substrates have inflow and outflow channels, wherein the respective downstream ends of the inflow channels and the upstream ends of the outflow channels are alternately closed off with gas-tight “plugs.” In this case, the exhaust gas that is to be purified and that flows through the filter substrate is forced to pass through the porous wall between the inflow channel and outflow channel, which delivers an excellent particulate filtering effect. The filtration property for particulates can be designed by means of the porosity, pore/radii distribution, and thickness of the wall. The porosity of the uncoated wall-flow filters is typically more than 40%, generally from 40% to 75%, particularly from 50% to 70% [measured according to DIN 66133, latest version on the filing date]. The average pore size (diameter) of the uncoated filters is at least 7 μm, for example from 7 μm to 34 μm, preferably more than 10 μm, in particular more preferably from 10 μm to 25 μm or most preferably from 15 μm to 20 μm [measured according to DIN 66133, latest version on the date of application]. The completed filters with a pore size of typically 10 μm to 20 μm and a porosity of 50% to 65% are particularly preferred.

The use of the wall-flow filter as an SCR-active catalyst support (known as an SDPF) is preferred. For this SCR treatment of the preferably lean exhaust gas, ammonia or an ammonia precursor compound is injected into the exhaust gas and both are conducted over a SCR-catalytically coated wall-flow filter produced according to the invention. The temperature above the SCR filter should be between 150° C. and 500° C., preferably between 200° C. and 400° C. or between 180° C. and 380° C. so that reduction can take place as completely as possible. A temperature range of 225° C. to 350° C. for the reduction is particularly preferred. Furthermore, optimum nitrogen oxide conversions are only achieved when there is a molar ratio of nitrogen monoxide to nitrogen dioxide (NO/NO₂=1) or the NO₂/NOx ratio=0.5 (G. Tuenter et al., Ind. Eng. Chem. Prod. Res. Dev. 1986, 25, 633-636; EP1147801B1; DE2832002A1; Kasaoka et al., Nippon Kagaku Kaishi (1978), 6, 874-881; Avila et al., Atmospheric Environment (1993), 27A, 443-447). Optimal conversions beginning with 75% conversion, already at 250° C. with simultaneously optimal selectivity to nitrogen, are only achieved, according to the stoichiometry of the reaction equation

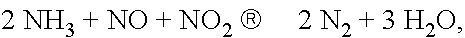

with an NO₂/NOx ratio of around 0.5. This applies not only to SCR catalysts based on metal-exchanged zeolites but to all common, i.e., commercially available, SCR catalysts (so-called fast SCRs). A corresponding NO:NO₂ content may be achieved with oxidation catalysts positioned upstream of the SCR catalyst.

Wall flow filters having an SCR-catalytic function are referred to as SDPF. These catalysts frequently possess a function for storing ammonia and a function whereby nitrogen oxides can react with ammonia to form harmless nitrogen. An NH₃-storing SCR catalyst can be designed in accordance with types known to the person skilled in the art. In the present case, this is a wall-flow filter which is coated with a material catalytically active for the SCR reaction and in which the catalytically active material, commonly called the “washcoat”, is present in the pores of the wall-flow filter. However, along with the—in the proper sense of the term—‘catalytically active’ component, this wall flow filter may also contain other materials, such as binders consisting of transition metal oxides, and large-surface carrier oxides, such as titanium oxide, aluminum oxide, in particular gamma-Al₂O₃, zirconium oxide, or cerium oxide. Also suitable as SCR catalysts are those that are made up of one of the materials listed below. However, it is also possible to use zoned or multilayer arrangements or even arrangements consisting of a plurality of components one behind the other (preferably two or three components) with the same materials as the SCR component or different materials. Mixtures of different materials on a substrate are also conceivable.

The actual catalytically active material used in this regard is preferably selected from the group of transition-metal-exchanged zeolites or zeolite-like materials (zeotypes). Such compounds are sufficiently familiar to the person skilled in the art. Preferred in this regard are materials from the group consisting of levynite, AEI, KFI, chabazite, SAPO-34, ALPO-34, zeolite ß, and ZSM-5. Zeolites or zeolite-like materials of the chabazite type, in particular CHA or SAPO-34, as well as LEV or AEI are particularly preferred. In order to ensure sufficient activity, these materials are preferably provided with transition metals from the group consisting of iron, copper, manganese, and silver. It should be mentioned in this respect that copper is especially advantageous. The ratio of metal to framework aluminum or, in the case of SAPO-34, the ratio of metal to framework silicon is normally between 0.3 and 0.6, preferably 0.4 to 0.5. The person skilled in the art knows how to equip the zeolites or the zeolite-like materials with the transition metals (EP0324082A1, WO1309270711A1, WO2012175409A1, and the literature cited therein) in order to be able to deliver good activity with respect to the reduction of nitrogen oxides with ammonia. Furthermore, vanadium compounds, cerium oxides, cerium/zirconium mixed oxides, titanium oxide, and tungsten-containing compounds, and mixtures thereof can also be used as catalytically active material.

Materials which in addition have proven themselves to be advantageous for the application of storing NH₃ are known to the person skilled in the art (US20060010857A1, WO2004076829A1). In particular, microporous solid materials, such as so-called molecular sieves, are used as storage materials. Such compounds, selected from the group consisting of zeolites, such as mordenites (MOR), Y-zeolites (FAU), ZSM-5 (MFI), ferrierites (FER), chabazites (CHA), and other “small pore zeolites,” such as LEV, AEI, or KFI, and β-zeolites (BEA), as well as zeolite-like materials, such as aluminum phosphate (AIPO) and silicon aluminum phosphate SAPO or mixtures thereof, can be used (EP0324082A1). Particularly preferably used are ZSM-5 (MFI), chabazites (CHA), ferrierites (FER), ALPO- or SAPO-34, and β-zeolites (BEA). Especially preferably used are CHA, BEA, and AIPO-34 or SAPO-34. Extremely preferably used are materials of the LEV or CHA type, and here maximally preferably CHA or LEV or AEI. Insofar as a zeolite or a zeolite-like compound as just mentioned above is used as catalytically active material in the SCR catalyst, the addition of further NH₃-storing materials can, advantageously, naturally be dispensed with. Overall, the storage capacity of the ammonia-storing components used can, in a fresh state at a measuring temperature of 200° C., be more than 0.9 g NH₃ per liter of catalyst volume, preferably between 0.9 g and 2.5 g NH₃ per liter of catalyst volume, and particularly preferably between 1.2 g and 2.0 g NH₃/liter of catalyst volume, and very particularly preferably between 1.5 g and 1.8 g NH₃/liter of catalyst volume. The ammonia-storing capacity can be determined using synthesis gas equipment. To this end, the catalyst is first conditioned at 600° C. with NO-containing synthesis gas to fully remove ammonia residues in the drilling core. After the gas has been cooled to 200° C., ammonia is then metered into the synthesis gas at a space velocity of, for example, 30,000 h⁻¹ until the ammonia storage in the drilling core is completely filled, and the ammonia concentration measured downstream of the drilling core corresponds to the starting concentration. The ammonia-storing capacity results from the difference between the amount of ammonia metered overall and the amount of ammonia measured on the downstream side based on the catalyst volume. The synthesis gas is here typically composed of 450 ppm NH₃, 5% oxygen, 5% water, and nitrogen.

So-called three-way catalysts are used for exhaust gas reduction for stoichiometrically burning engines. Three-way catalysts (TWCs) have long been known to those skilled in the art and have been legally prescribed since the eighties in the last century. The actual catalyst mass here consists for the most part of a high-surface, oxidic substrate material, on which the catalytically active components are deposited with the finest distribution. The precious metals of the platinum group, platinum, palladium and/or rhodium are particularly suitable as catalytically active components for cleaning stoichiometrically composed exhaust gases. For example, aluminum oxide, silicon dioxide, titanium oxide, zirconium oxide, cerium oxide and their mixed oxides, and zeolites are suitable as substrate materials. What are known as active aluminum oxides having a specific surface (BET surface, measured according to DIN 66132—the latest version at the time of filing) of more than 10 m²/g are preferably used. Moreover, three-way catalysts include oxygen-storing components to improve the dynamic conversion. These include cerium/zirconium mixed oxides which are optionally provided with lanthanum oxide, praseodymium oxide and/or yttrium oxide. Meanwhile, zoned and multilayer systems having three-way activity have also become known (U.S. Pat. No. 8,557,204; 8,394,348). If such a three-way catalytic converter is located on or in a particle filter, this is referred to as a cGPF (catalyzed gasoline particle filter; for example EP 2650042B1).

In the context of the invention, in-wall coating means that generally more than 80% of the coating composition is present in the wall of the wall-flow filter. 80% of the coating composition is present in the longitudinal section of the wall of the wall-flow filter in a region below the surface of the wall. This can be determined by means of corresponding recordings and computer-assisted evaluation methods.

Surprisingly, the present invention makes it possible to achieve an improved coating of wall-flow filters when the coating is applied from below, for example by pumping the coating suspension (pressure difference across the wall-flow filter) and subsequent removal of excess coating suspension by a pressure difference reversal, preferably downwards. By applying a liquid zone, the capillary forces during coating with coating suspension can be minimized, because in particular the smaller pores are already filled with liquid when the coating suspension reaches the wetted position. This results in a lower concentration of the suspension and thus to a smaller increase in filter cake thickness in the channels. The gradient for the coating in the coating direction is reduced and the drop in permeability in the coating direction is reduced. Against the background of the known prior art, this was not to be expected.

1. Method for coating a wall-flow filter with a coating suspension that gives the filter a catalytic activity during exhaust gas cleaning, wherein the wall-flow filter is brought into contact with a liquid comprising water in a first step and a coating suspension is applied to the wall-flow filter in a second step,
characterized in that
the coating suspension is one that meets the following criteria:
Q3 values of the grain size distribution (d90−d10)/d50<5 of the particles present in the suspension;
viscosity <2000 mPas at a shear of 20 1/s.

2. Method according to claim 1,
characterized in that
in the second step, the coating suspension is introduced in excess into the wall-flow filter from below by applying a pressure difference across the vertically locked wall-flow filter, and subsequently a pressure difference reversal removes an excess of the coating suspension from the wall-flow filter.

3. Method according to claim 1,
characterized in that
in the first step, the wall-flow filter is contacted with the liquid comprising water over less than the entire length of the filter.

4. Method according to claim 1,
characterized in that
the filter is already vertically locked in the first step and is rotated by 180° after the first step before the coating suspension is introduced into the filter in the second step.

5. Method according to claim 1,
characterized in that the coating suspension is predominantly introduced into the wall of the filter.

6. Method according to claim 1,
characterized in that
the average particle size d50 of the Q3 distribution in the coating suspension in relation to the average pore diameter D50 of the Q3 distribution is >33%.

7. Method according to claim 1,
characterized in that
the coating suspension has a density between 1050 kg/m³ and 1700 kg/m³.

8. Method according to claim 1,
characterized in that
after the coating and subsequent drying of the coated filter, the gradient of the coating suspension in the longitudinal direction is less than 10%.

9. Wall-flow filter produced according to claim 1.

10. Wall-flow filter according to claim 9,
characterized in that
it is provided with an SCR-active coating suspension.

11. Use of the wall-flow filter according to claim 9 for reducing harmful exhaust gas components of internal combustion engines.
